(19) United States
(12) Patent Application Publication
(10) Pub. No.: US 2010/0276580 A1
(43) Pub. Date: Nov. 4, 2010

(54) Quantitative Calibration Method and System for Genetic Analysis Instrumentation

(75) Inventors: Muhammad A. Sharaf, Oakland, CA (US); Wanli Bi, San Ramon, CA (US); Kenneth J. Livak, San Jose, CA (US)

Correspondence Address: LIFE TECHNOLOGIES CORPORATION;C/O INTELLEVATE, P.O. BOX 52050, MINNEAPOLIS, MN, 55402, US

(73) Assignee: LIFE TECHNOLOGIES CORPORATION, Carlsbad, CA (US)

(21) Appl. No.: 12/611,892

(22) Filed: Nov. 3, 2009

Related U.S. Application Data
(63) Continuation of application No. 11/428,385, filed on Jul. 1, 2006, now abandoned.

(51) Int. Cl. G12B 13/00; G01N 21/64; G01N 21/25

(52) U.S. Cl. 250/252.1

(57) ABSTRACT

Aspects of the present invention provide a method and apparatus of generating a calibration matrix for a spectral detector instrument. A calibration plate contains one or more dye mixtures in each well of the calibration plate at known absolute concentration. From the calibration plate, aspects of the present invention are used to prepare a concentration matrix based on the dyes used in the assay and the different dye mixtures used in the calibration plate. An excitation source exposes the calibration plate causing the spectral species in each of the wells to fluoresce. The emission spectra for the different dye mixtures of dyes as gathered by the spectral detector instrument at different points in the range of spectra is used to generate a spectral matrix. Bilinear calibration is performed on the concentration matrix and the spectral matrix as to determine a calibration matrix relating spectra directly to absolute concentrations.

### CROSS-REFERENCE TO RELATED APPLICATION

This application is a continuation of patent application Ser. No. 11/428,385 filed Jul. 1, 2006, which is incorporated herein by reference.

### INTRODUCTION

Real-time polymerase chain reaction (real-time PCR) instruments use a cycle threshold (Ct) as an indication of the gene expression associated with an underlying target. The gene expression of a specific sample polynucleotide provides an indication of its underlying genes. Generally, real-time PCR obtains Ct value measurements by performing a thermal cycle and detecting a corresponding change in the signal emitted from a fluorescent dye or spectral species. Consequently, accurately determining the Ct value is an important part of obtaining more accurate experimental results and quantification of the gene expression for the target of interest.

Variability in Ct determination is a factor to consider if gene expression for a target is to be accurately measured and compared. In some cases, Ct variability may occur as components on an individual instrument are broken-in or wear through normal usage over time. Other cases of Ct variability may arise when multiple instruments are used to measure the gene expression for a given target. Yet another set of factors contributing to Ct variability may include: pipeting errors, instrument sensitivity drift, different thresholds and different baselines.

A number of diagnostic assays attempt to control the Ct values using a baseline value and threshold for a particular assay. The baseline value offsets background signals resulting from fluorescence levels that may fluctuate due to changes in the reaction medium. Generally, the baseline value is established early in a reaction and prior to the detection of a change in fluorescent signal of the target sample. The fluorescence levels detected at this point can readily be attributed to background signal. Once the baseline is set, the threshold is typically set at some number of standard deviations above the mean baseline fluorescence. Further additional adjustments ensure the threshold is in the exponential phase of the amplification curve, as well as meeting other criteria. This approach works well when the spectral sensitivity in the instrument does not vary over time or across instruments.

However, the baseline approach above tends not to work well in experiments performed over time on a single instrument or on multiple instruments. These instruments tend to have various spectral sensitivities and report a non-uniform spectral response. Some of the more notable factors causing spectral non-uniformity include but are not limited to different optics and optical paths, different sensitivities across the spectra and varying usage or age of the instruments. Even in the same instrument, spectral non-uniformity may arise from light source characteristics changing over time, paths of light being received differently at various well positions in a plate, variations in the optical covers used to seal the wells in the plate and many other reasons. Overall, spectral non-uniformity makes it difficult to achieve reproducible Ct values and compare results from one or multiple instruments running experiments over any length of time.

Spectral calibration techniques are therefore an important part of operating instruments involved in genetic analysis. Multiple dyes used in single nucleotide polymorphism (SNP) assays need spectral calibration that reflects not only how each dye behaves alone but in combination with several other dyes like Fam, Tet, Vick, Ned and even Rox, the internal standard. Multicomponent analysis is used to resolve and identify the individual emission profiles making up the full spectrum measured during genetic analysis. A conventional unweighted least squares approach is currently used to estimate the amounts of various dyes and their association with spectrum.

To simplify computations and use in analysis, these individual emission profiles are each normalized to unit heights based on a peak intensity measured for the particular dye. While the actual peak intensity value for each dye is lost, the results are still used for various relative and qualitative measurements. The resulting emission spectra often referred to as the calibration spectra or pure dye spectra appear as several uniform curves having intensities along a unit height with peaks shifted along different points of the spectrum according to their particular spectral sensitivity.

Unfortunately, the loss of quantitative information during normalization greatly limits the value of the calibration spectra in subsequent genetic analysis. Normalization to unit heights does not preserve the actual intensity levels and therefore calculations cannot reflect true concentrations and dye amounts. This makes comparisons between instruments or lines of instruments difficult as the values associated with the normalized results have arbitrary units. For example, scatter plots from allelic discrimination SNP assays on different machines cannot be compared as the information is not quantitatively accurate.

Even relative measurements of dyes to one and another cannot be made as the results of normalization. The results of unweighted least squares calculations on spectra normalized to unit heights produces dye amounts in arbitrary units. This may put into question many different types of qualitative and quantitative measurements currently made and used on a single machine.

Normalization also increases sensitivity to spectral overlap of the dyes when doing multicomponent analysis. For example, multicomponent analysis using Fam, Tet, Vic, Ned and Rox in multiplexed SNP assays may be greatly affected by the high degree of overlap between the dyes Fam and Tet. The continued use of conventional unweighted least squares analysis may not allow accurate multicomponent analysis on dye combinations with large spectral overlap. This may inhibit and delay the development process as dyes with lesser spectral overlap needs to be developed.

It is desirable to reduce the effects of spectral non-uniformity that occur between different instruments or the same instrument measuring spectral species over time. Spectral calibration approaches should be robust and work with a variety of instruments and not be limited by spectral overlap present in a dye.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a schematic illustrating a system for spectral detection and calibration in accordance with some implementations of the present invention;

FIG. 2 is a schematic illustration of a system used for fluorescent signal detection in accordance with implementations of the present invention;

FIG. 3A provides a graphical representation of the bilinear calibration as it relates to relating spectrum and spectral species concentration amounts;

FIG. 3B depicts a portion of a spectral matrix X_{S(pectrum)} representing the spectral domain in accordance with implementations of the present invention;

FIG. 3C depicts a portion of a concentration matrix Y_{C(oncretation)} representing the chemical or biological domain in accordance with implementations of the present invention;

FIG. 3D depicts the resulting calibration matrix K_{calibrate} generated as a result of the bilinear calibration as applied to spectral matrix X_{S} and concentration matrix Y_{C} in accordance with aspects of the present invention;

FIG. 4 is a flowchart diagram of operations performed create the calibration matrix K_{calibrate} using bilinear calibration as described in accordance with one implementation of the present invention;

FIG. 5A contains a calibration set used to populated a concentration matrix Y_{C} with 32 samples in accordance with one implementation of the present invention;

FIG. 5B is a graph plotting concentration values for Y_{c-Unknown} samples using calibration matrix K_{calibrate} in accordance with one implementation of the present invention;

FIG. 6 is a flowchart diagram of the operations for converting between spectral response and absolute concentrations in accordance with implementations of the present invention; and

FIG. 7 is a block diagram of a system used in operating an instrument or method in accordance with implementations of the present invention.

### SUMMARY

Aspects of the present invention provide a method and apparatus of generating a calibration matrix for a spectral detector instrument. An initial operation receives a calibration plate containing one or more dye mixtures in each well of the calibration plate at known absolute concentration. From the calibration plate, aspects of the present invention are used to prepare a concentration matrix based on the dyes used in the assay and the different dye mixtures used in the calibration plate. An excitation source operating over a range of spectra exposes the calibration plate causing the one or more spectral species in each of the wells to fluoresce. The emission spectra for the different dye mixtures of dyes as gathered by the spectral detector instrument at different points in the range of spectra is used to generate a spectral matrix. Bilinear calibration is performed on the concentration matrix and the spectral matrix as to determine a calibration matrix relating spectra directly to absolute concentrations.

These and other features of the present teachings are set forth herein.

### DESCRIPTION

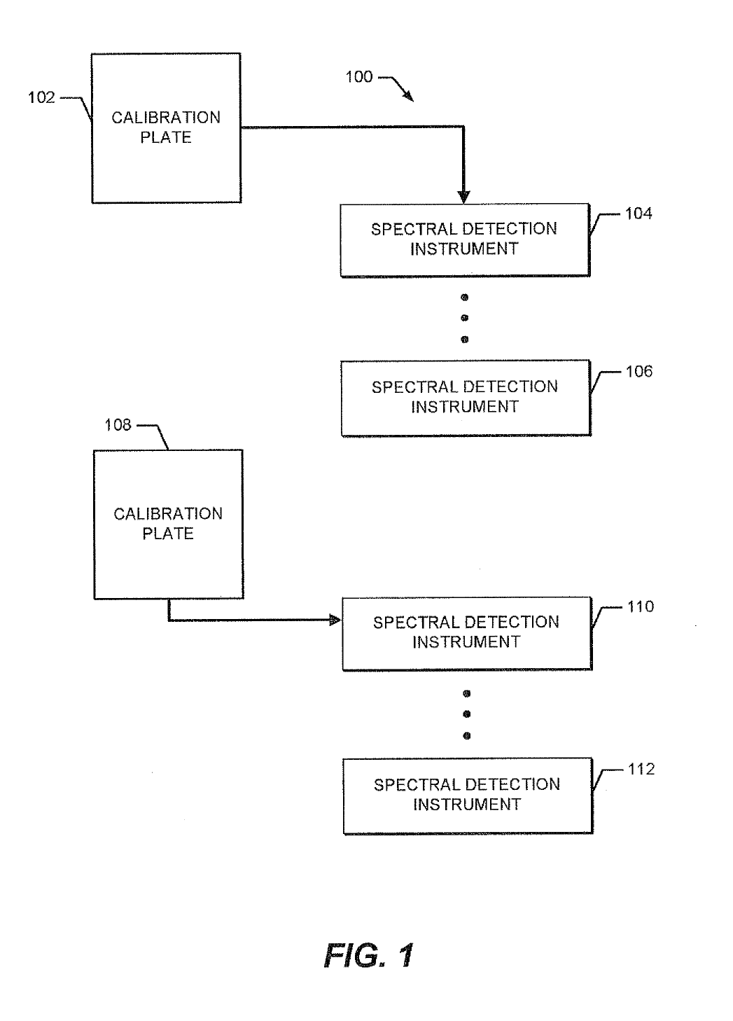

FIG. 1 is a schematic illustrating a system for spectral detection and calibration in accordance with some implementations of the present invention. System 100 includes a calibration plate 102, spectral detection instrument 104 through 106, a calibration plate 108 and spectral detection instruments 110 through 112. For example, each spectral detection instrument generally includes a spectral detector capable of identifying certain spectral species emitted from a sample and a calibration component operable in accordance with various aspects of the present invention that calibrates spectral information gathered. Calibration plate 102 includes one or more spectral species sealed with heat, pressure and/or mechanically in multiple wells by a seal or cap. Similarly, calibration plate 108 may contain the same or different combination of spectral species sealed likewise in the same number of wells.

Calibrating multiple spectral detection instruments in accordance with aspects of the present invention allows increased processing throughput and an aggregation and/or comparison of results produced. In real-time PCR, this enables multiple real-time PCR instruments calibrated in accordance with implementations of the present invention to work together even though the instruments may have different spectral sensitivities and spectral response to the spectral species.

Both calibration plate 102 and calibration plate 108 contain accurately measured quantities. However, it is not critical that calibration plate 102 and calibration plate 108 contain the exact same concentrations as long as the absolute concentration amounts are accurately known. As will be described later herein, a calibration matrix is developed for each instrument allowing spectral response measured by the instrument to be converted directly to an actual measure of dye concentration. Using actual dye concentration amounts allows results from one instrument to be compared with other instruments regardless of the make, model, age or spectral efficiency of the equipment.

Nonetheless, each calibration plate 102 is manufactured with care as the actual dye concentrations and mixtures need to be carefully recorded. The mixture of dyes in calibration plate 102 generally are related to the dyes and dye combinations used in an assay. For example, the dye mixtures selected for use in calibration plate 102 should reflect those dye combinations used by the assay to detect a particular target sample.

Using calibration plate 102, a resulting calibration matrix created in accordance with implementations of the present invention not only reflects the dyes used in the assay but accommodates for the spectral overlap between various dye combinations and their interactions. Consequently, aspects of the present invention work well despite spectral overlap between dyes thus providing flexibility in the dye combinations used for spectral detection.

For example, a predetermined mixture of up to five different unquenched dyes inserted in each well of a calibration plate fluoresce a signal in the presence of certain wavelengths of light emitted by the instrument. In the case of real-time PCR instruments, the five different dyes, reporters or reagents inserted in each well may be selected from a set including: FAM, SYBR Green, VIC, JOE, TAMRA, NED CY-3, Texas Red, CY-5, Hex, ROX (passive reference) or any other fluorochrome. Spectral overlap and interaction are taken into consideration and therefore may take place between these spectral species without affecting the calibration operation. Instead of normalizing to unit values, implementations of the present invention records quantitative spectral response in correlation to the known actual concentrations and mixtures of dyes in the calibration plate. As will be described in further detail later herein, aspects of the present invention derive the calibration matrix using one or more variations of bilinear calibration creating a direct transformation between spectrum detected and an actual concentration.

It is contemplated that alternate implementations may use greater or fewer than five dyes depending on the specific instrument and measurements being made. Also, while fluorescence is one source of signal described in detail herein, aspects of the present invention can also be applied and used in conjunction with instruments measuring phosphorescence, chemiluminescence and other signal sources.

The same calibration plate 102 or different calibration plates may be used by an arbitrary number of spectral detection and calibration instruments 104 through 106 to detect various spectral species. Generally, each of spectral detection instrument 104 through 106 is likely to detect different spectral species in calibration plate 102 due to differences in optics, different quantum efficiencies of detectors/cameras sampling the signals produced, varying sensitivities to spectra between instruments and other variations between the instruments.

Even the same spectral detection instrument 104 may detect different spectral features taken at subsequent time intervals for the same spectral species in calibration plate 102. These differences can be attributed to wear of the instrument and small changes in the spectral sensitivity of the same detector over time, degradation of an excitation source in the detector instrument or any other number of changes to the instrument and/or the environment that may occur over time. Spectral detection instrument 104 may likely to detect a different quantification of spectral species from well to well in calibration plate 102 due to the different light paths to each well and variations in the optical seals used to cap each well. Accordingly, a calibration matrix may be developed for an instrument operating on all the wells in a plate or for each individual well in the plate should it be deemed necessary under the circumstances.

The calibration matrix derived for each instrument accounts for the different signal measurements of the spectral species measured in light of the predetermined or known concentrations and mixtures of the one or more spectral species included in each well of calibration plate 102. Because absolute concentrations are used, a calibration matrix derived in accordance with aspects of the present invention not only compensates for differences between several instruments or the same instrument over time but also for other spectral variations that may occur for other reasons. The calibration matrix is to convert measured spectral response from target samples into concentrations of spectral species.

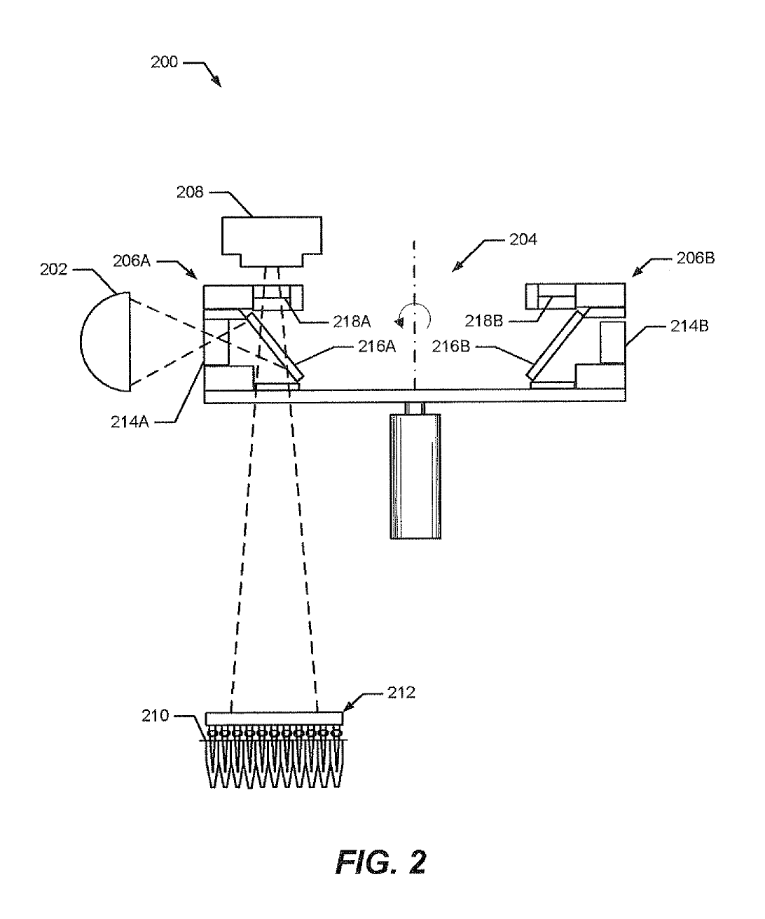

FIG. 2 is a schematic illustration of a system used for fluorescent signal detection in accordance with implementations of the present invention. Detection system 200 is an example of spectral detection and calibration instrument 104 previously described in FIG. 1. Detection system 200 can be used with real-time PCR processing in conjunction with aspects of the present invention. As illustrated, detection system 200 includes a light source 202, a filter turret 204 with multiple filter cubes 206, a detector 208, a microwell tray 210 and well optics 212. A first filter cube 206A can include an excitation filter 214A, a beam splitter 216A and an emission filter 218A corresponding to one spectral species selected from a set of spectrally distinguishable species to be detected. A second filter cube 206B can include an excitation filter 214B, a beam splitter 216B and an emission filter 218B corresponding to another spectral species selected from the set of spectrally distinguishable species to be detected.

Light source 202 can be a laser device, Halogen Lamp, arc lamp, Organic LED, an LED lamp or other type of excitation source capable of emitting a spectra that interacts with spectral species to be detected by system 200. In this illustrated example, light source 202 emits a broad spectrum of light filtered by either excitation filter 214A or excitation filter 214B that passes through beam splitter 216A or beam splitter 216B and onto microwell tray 210 containing one or more spectral species. Further information on light sources and overall optical systems can found in U.S. Patent Application 20020192808 entitled “Instrument for Monitoring Polymerase Chain Reaction of DNA”, by Gambini et al. and 200438390 entitled “Optical Instrument Including Excitation Source” by Boege et al. and assigned to the assignee of the present case.

Light emitted from light source 202 can be filtered through excitation filter 214A, excitation filter 214B or other filters that correspond closely to the one or more spectral species. As previously described, each of the spectrally distinguishable species may include one or more of FAM, SYBR Green, VIC, JOE, TAMRA, NED, CY-3, Texas Red, CY-5, Hex, ROX (passive reference) or any other fluorochromes that emit a signal capable of being detected. In response to light source 202, the target spectral species and selected excitation filter, beamsplitter and emission filter combination provide the largest signal response while other spectral species with less signal in the bandpass region of the filters contribute less signal response. Multicomponent analysis in accordance with the present invention is a product of transforming spectral response directly into actual concentration amounts of spectral species through the calibration matrix. Equation 1 below illustrates the transformation from spectral response to a multicomponent concentration of spectral species/dye using the calibration matrix of the present invention:

X_{spectrum}·K_{calibrate}=Y_{con} (1)
Where:
X_{spectrum} is an spectral response matrix of size n_{mix-row}×n_{bin-col} for all spectral species/dye mixtures in a tray.
   nₘᵢₓ identifies a mixture of spectral species being detected by the instrument.
   n_{bin} is the number of detector channels/filters being detected by the instrument.
   K_{calibrate} is a calibration matrix of size n_{bin-row}×n_{dyes-col} for different mixtures of dyes/spectral species used for calibration.
   Y_{con} is a matrix of the concentration of each dye in the sample of size n_{mix-row}×n_{dye-col} corresponding to a particular mixture in a tray.

The actual spectral response matrix X_{spectrum} contains actual spectral response measurements measured from spectral species in different combinations. The actual spectral response measurements are not normalized to unit values. In one implementation, the column n_{bin} represents a spectral channel of the instrument and the row nₘᵢₓ corresponds to a mixture of dyes/spectral species of interest. For example, one column may represent a bin sensitive to range of 495 to 525 nm (λ) with the rows the corresponding to different predetermined spectral species/dye mixtures in calibration plate.

It is important to note that the measured spectral response in the spectral response matrix X_{spectrum} is not normalized thus quantitative information is preserved. Spectral response and/or values derived from the actual spectral response measured on one instrument can be compared directly with other instruments or even different lines of instruments. Each coefficient in the concentration calibration matrix K_{calibrate} represents the concentration of each spectral species corresponding to spectral response detected for a given sample. Accordingly, the spectral response matrix X_{spectrum} multiplied by the concentration calibration matrix K_{calibrate} results in the concentration of various spectral components signal detected Y_{con}.

Calibration matrix K_{calibrate} is a n_{bin-row}×n_{dyes-col} matrix that provides direct correlation between a spectral response and different dye mixtures. As will be described in further detail later herein, the relationship between spectrum and actual concentrations of individual dyes indicated in concentration calibration matrix K_{calibrate} is derived in accordance with the present invention using bilinear calibration techniques. Because actual not normalized spectrum is used, the dye concentration results from calibration matrix K_{calibrate} can be quantified and readily used. For example, this allows results between instruments and lines of instruments to be compared.

Referring to FIG. 2, microwell tray 210 can be a calibration plate designed in accordance with implementations of the present invention containing one or more unquenched dyes or reporters useful in calibrating system 200. Each microwell tray 210 can include a single well or any number of wells however, typical sets include 96-wells, 384-wells and other multiples of 96-wells. Of course, many other plate configurations having different multiples of wells other than 96 can also be used. If microwell tray 210 includes multiple wells then the different optical paths to each of the wells in microwell tray 210 from detector 208 may contribute to producing a non-uniform spectral response.

The particular combination of dyes is sealed in microwell tray 210 using heat and an adhesive film to ensure they do not evaporate or become contaminated. Due to uneven melting of the film upon sealing, the optical transmission of light may vary from well-to-well in microwell tray 210 depending on the thickness of the seal, angle and position of light passing through the heat sealed covers, different optical paths and other potential variations between the wells. As previously mentioned and described in further detail later herein, aspects of the present invention may be used to generate a calibration matrix for each different well position in microwell tray 210 to accommodate for these and other variations. Calibration matrix generated for each well also compensates for variation in spectral response due to the many different angles of entry for the light in the various wells in microwell tray 210 as well as the angles of light through the various filters. Alternatively, the same calibration matrix can be used for all the wells if the light path between detector 208 and each well is essentially the same.

Detector 208 receives the signal emitted from spectral species in microwell tray 210 in response to light passing through the aforementioned filters. Detector 208 can be any device capable of detecting fluorescent light emitted from multiple spectrally distinguishable species in the sample. For example, detector 208 can be selected from a set including a charge coupled device (CCD), a charge induction device (CID), a set of photomultiplier tubes (PMT), photodiodes and a CMOS device. Information gathered by detector 208 can be processed in real-time in accordance with implementations of the present invention or through subsequent post-processing operations to correct for the non-spectral uniformity.

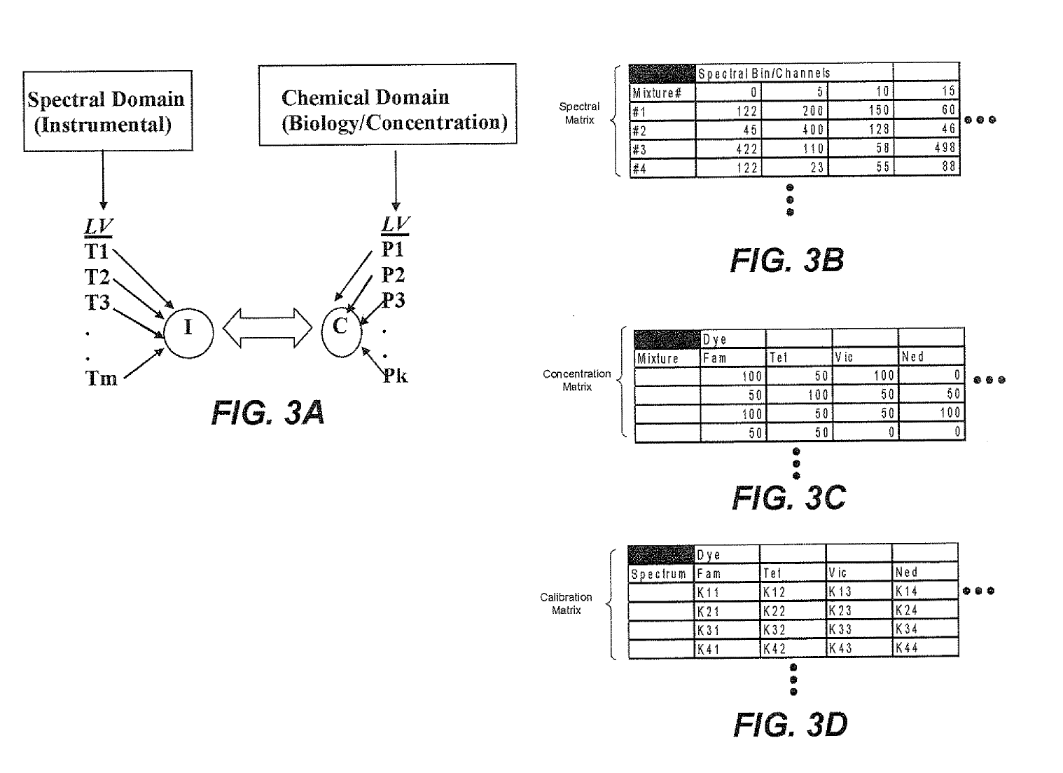

FIG. 3A provides a graphical representation of the bilinear calibration as it relates to relating spectrum and spectral species concentration amounts. The primary goal is to create a model that relates two domains to one another: a spectral domain of an instrument and the chemical domain associated with the biology. A set of linear equations described later herein are solved for each instrument creating a calibration matrix that relates the spectral response of the instrument to concentration of dyes for the selected assay. Initially, a calibration plate with known concentrations is used to derive this calibration matrix for the instrument. Thereafter, the calibration matrix can be used to transform spectral response of a target sample using the same assay into an absolute measure of concentration.

FIG. 3B depicts a portion of a spectral matrix X_{S(pectrum)} representing the spectral domain in accordance with implementations of the present invention. Spectral matrix X_{S} relates various predetermined known mixtures of spectral species with their spectral response for various bins of the spectral instrument. For example, spectral bin 0 of the spectral instrument has an absolute measurement of 122 for mixture #1, 45 for mixture #2, 422 for mixture #3 and 122 for mixture #4. Spectral matrix X_{S} in one implementation has the dimensions of n_{mix-row}×n_{ch-col}.

FIG. 3C depicts a portion of a concentration matrix Y_{C(oncretation)} representing the chemical or biological domain in accordance with implementations of the present invention. Concentration matrix Y_{C} relates various dyes in the assay with typical dye mixtures likely to arise when using the assay in a particular application. The typical dye mixtures are specifically selected for the assay and application being performed to model both the individual spectral response as well as the response of the dyes interacting as a result of spectral overlap or other relations. For example, mixture #1 in concentration matrix Y_{C} has 100 nM Fam, 50 nM Tet, 100 nM Vic and 0 nM Ned and potentially other spectral species/dyes (not pictured). The concentration matrix Y_{C} may also be referred to as a “calibration set” Y_{C} as it is used in part to generate the calibration matrix K_{calibrate} previously described. Concentration matrix Y_{C} in one implementation has the dimensions of n_{mix-row}×n_{dyes-col}.

FIG. 3D depicts the resulting calibration matrix K_{calibrate} generated as a result of the bilinear calibration as applied to spectral matrix X_{S} and concentration matrix Y_{C} in accordance with aspects of the present invention. As previously described, calibration matrix K_{calibrate} can be used to transform detected spectrum stored in spectral response matrix X_{S} into an absolute measure of concentration reflected in Y_{C}. It is contemplated that values in calibration matrix K_{calibrate} are used for absolute calibration and therefore not limited to positive, negative, integer, floating point, a specific range of values, a combination of integers and/or floating point or any other values. Accordingly, the variable Kij has been inserted in the calibration matrix FIG. 3D to indicate compatibility with a wide range of values.

A set of linear equations are established to model the relationship between X_{S} and Y_{C} and eventually derive calibration matrix K_{calibrate}.

X_{S}=TP+E (2)

T_{C}=UQ+F (3)

U=TB+H (4)

Where:
X_{S} is spectral matrix relates various predetermined known mixtures of spectral species with their spectral response for various bins of the spectral instrument.
Y_{C} relates various dyes in the assay with typical dye mixtures likely to arise when using the assay in a particular application.
T is a matrix of X scores.
P is a matrix of X factors.
U is a matrix of Y scores.
B is a diagonal matrix.
Q is a matrix of Y factors.
E, F, H are residual matrices.

A few preliminary operations may be used to re-express this relationship and prepare for solving using a mathematical modeling program like MATLAB (The Math Works, Inc. Natick, Mass.) or any other suitable mathematical modeling software or programming language. Accordingly, the inner relationship U can substituted in Y_{C} to produce the following relationship.

Y_{C}=TBQ+J (5)
Where:
   J is new residual matrix.

Further X_{S} and Y_{C} can also be rewritten and expressed in terms of the now common matrix T of X scores as follows:

X_{S}=TP+E (2)

Y_{C}=Tq+J (5)

In operation, bilinear calibration methods are first used to estimate matrices T, P and q in the calibration phase of the calculation. Next, to identify a sample concentration Y_{c-Unknown} from spectral response \vec{X}_{S-unknown} we calculate corresponding new value T_{unknown} with P. The T_{unknown} is then used in conjunction with q in (5) to determine Y_{c-Unknown}.

Alternatively, various algebraic matrix operations can be performed to replace equations (2) and (5) with a single matrix operation as depicted in equation (1). We are able to derive the calibration matrix \vec{K}_{calibrate} and the following more direct relationship:

X_{s-Unknown}·K_{calibrate}=Y_{c-Unknown} (6)/(1)

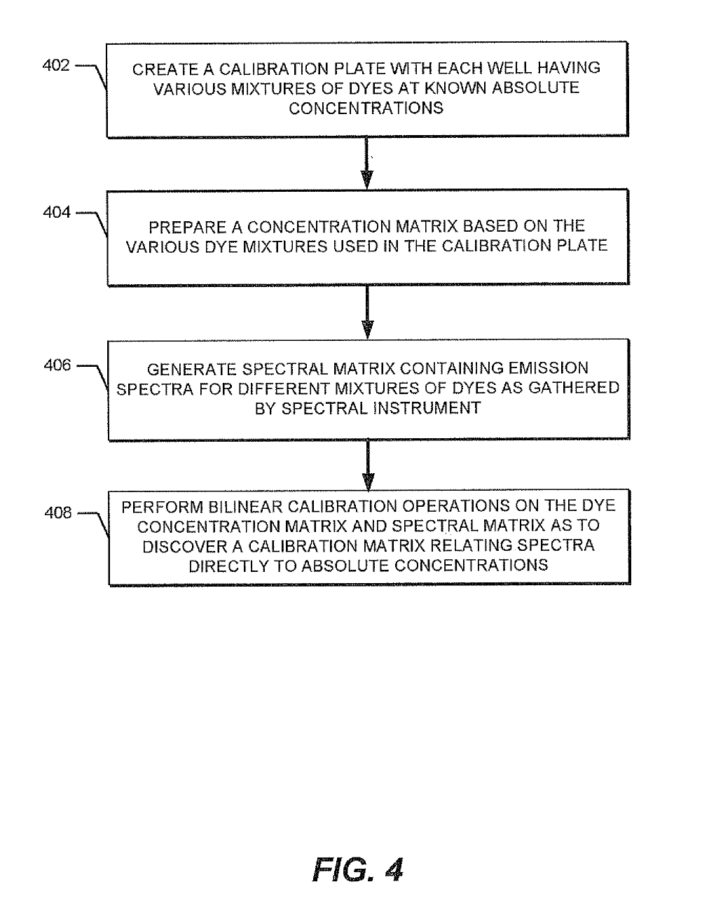

FIG. 4 is a flowchart diagram of operations performed create the calibration matrix K_{calibrate} using bilinear calibration as described. Initially, aspects of the present invention create a calibration plate with each well having various combinations of dyes at known absolute concentrations as encountered in an assay (402). The number of dye mixtures selected generally should be larger enough to cover an expected spectral response for a given assay and application. Additional dye mixtures may include likely statistical variations of the expected spectral response provided the accuracy of the instruments and spectral species/dies as well as spectral response from empty wells and other anomalies. As previously described, it is important that the dye mixtures placed in the various wells of the calibration plate are accurately measured and recorded but do not have to be identical.

Next, aspects of the present invention are given a concentration matrix Y_{C} based on the various dye mixtures used in the calibration plate (404). The concentration matrix accurately records the known concentrations of spectral species/dyes placed in the calibration plate. If there are fewer different mixtures of dyes than wells in the plate, it is possible that the same mixture of dyes appear multiple times in the calibration plate. It is contemplated that using a larger number of dye mixtures may improve the results as a greater number of possibilities are being measured and incorporated.

Using the calibration plate, a spectral detection instrument records emission spectra for different mixtures of dyes and stores in a spectral matrix X_{S} (406). Aspects of the present invention perform bilinear calibration operations on the concentration matrix Y_{C} and spectral matrix X_{S} as to discover a calibration matrix K_{calibrate} relating spectra directly to absolute concentrations (408).

Aspects of the present invention can be solved using various programming languages and/or mathematical modeling tools. Accordingly, the following pseudocode outlines one solution for performing bilinear calibration given the concentration matrix Y_{C} and spectral matrix X_{S} along with several other variables. It is contemplated this pseudocode below could be performed most readily in Java, MATLAB or even C programming language.

function [bilin_cal_mat] = bilin_cal(SS, CC, NLV, Nchannels, Ndyes, Nmixtures)
%
%

| | |
|---|---|
| % | INPUTS: |
| % | ----------- |
| % | (1) SS is of size Nmixtures X Nchannels -- the matrix bolding the |
| | emission calibration spectra |
| % | (2) CC is of size Nmixtures X Ndyes -- the matrix holding the |
| | concentration levels of the calibration matrix |
| % | (3) NLV is the number of latent variables -- in our case it should be the |
| | number of dyes |
| % | (4) Nchannels is the number of acquisition spectral channels/bins |
| % | (5) Ndyes is the number of dyes in the calibration set |
| % | (6) Nmixtures is the number of mixtures of dyes used in the calibration |
| | set |
| % | |
| % | OUTPUT: |
| % | ------------ |
| % | (1) cal_mat is of size Nchannels X Ndyes -- the bilinear calibration matrix |
| % | |
| % | |
| % | |
| % | Author: Muhammad Sharaf |
| % | Copyright 2002 -- Applied Biosystems |

```
%
%
%  Copy SS & CC to x and y
for kk = 1 :  Nmixtures
    for jj = 1 : Nchannels
        x(kk,jj) = SS(kk,jj);
    end
end
%
for kk = 1 :  Nmixtures
    for jj = 1  : Ndyes
        y(kk,jj) = CC(kk,jj);
    end
end
%
%  start extracting the NLV latent varibles
%
for h = 1 :  NLV
    % compute x transpose (xt) of size (Nchannels X Nmixtures)
    for kk = 1 :  Nchannels
        for jj = 1  :  Nmixtures
            xt(kk,jj) = x(jj,kk);
        end
    end
      % compute the product xt*y (= xy), xy is of size (Nchannels X Ndyes )
    for kk = 1  :  Nchannels
        for jj = 1 : Ndyes
            xy(kk,jj)  = 0.0;
            for nn = 1 : Nmixtures
                xy (kk,jj) =xy (kk,jj) + xt (kk,nn)*y (nn,jj);
            end
        end
    end
      %
    % compute xy transpose, xyt, of size (Ndyes X Nchannels)
    for kk = 1 :  Ndyes
        for jj = 1  :  Nchannels
            xyt (kk,jj) = xy (jj,kk);
        end
    end
    % compute the product (xyt * xy). This is square matrix of size (Ndyes X Ndyes)
    for kk = 1 : Ndyes
        for jj = 1 : Ndyes
            xytxy(kk,jj) = 0.0;
            for nn = 1 : Nchannels
                xytxy (kk,jj) = xytxy (kk,jj) + xyt (kk,nn) * xy (nn,jj);
            end
        end
    end
    %
    % estimate the singular value decomposition (SVD) of the (xytxy) matrix
    [pt,s,qt] = svd  (xytxy);  % This calls a built in Matlab function
    %
    %  pt is of size Ndyes X Ndyes
    %  s is of size Ndyes X Ndyes
    %  qt is of size Ndyes X Ndyes
    %
      for jj = 1:Ndyes
        q(h,jj) = qt(jj,1);  % q is of size (NLV X Ndyes)
    end
    %
    % calculate the product of xy and the first eigenvector of qt, normalize by the square
      % root of the
    % first singular value and store in w.  w is of size Nchannel X NLV
%
for jj = 1 :  Nchannels
    w(jj,h) = 0;
    for kk = 1 :  Ndyes
        w (jj,h) = w (jj,h) + xy (jj,kk)* qt (kk,1);
    end
    w (jj,h) = w (jj,h)/sqrt(s(1,1));
end
%
% calculate t by right multiplying x by w, t is of size (Nmixtures X NLV)
%
for kk = 1 : Nmixtures
    t(kk,h)  = 0;
    for jj = 1:Nchannels
        t (kk,h) = t (kk,h) + x (kk,jj) * w (jj,h);
    end
  end
  %
%
% Compute u the product of y and the first eigen vector of qt, u is of size
    % (Nmixtures X NLV)
%
for kk  = 1 : Nmixtures
    u (kk,h) = 0;
    for jj = 1 : Ndyes
        u (kk,h) = u (kk,h) + y (kk,jj) * qt (jj,1);
    end
  end
%
% compute the sum of Squares on t
%
tsqr = 0;
for kk = 1: Nmixtures
    tsqr  = tsqr + t(kk,h)\hat{ }2;
end
%
%  Calculate p by left multiplying x by t(h) as a row vector and normalize by t
  %sum of square
%  p is of size (NLV X Nchannels)
%
    for jj = 1 : Nchannels
      p (h,jj) = 0;
        for  kk = 1 : Nmixtures
            p (h,jj) = p (h,jj) + t (kk,h) * x (kk,jj);
        end
        p (h,jj) = p (h,jj)/tsqr;
    end
%
%
% compute b coefficients
%
b(h) = 0;
for kk = 1: Nmixtures
    b(h) = b(h) + u (kk,h) * t (kk,h);
end
b(h) = b(h)/tsqr;
%
%
%
    % And finally deflate x and y and start over until h latent variables are extracted
    %
      for jj = 1 : Nmixtures
        for kk = 1 : Nchannels
            x (jj,kk) = x (jj,kk) − t (jj,h) * p(h,kk);
        end
    end
    %
    for jj = 1 : Nmixtures
        for kk = 1 : Ndyes
            y(jj,kk) = y (jj,kk) − b(h) * t (jj,h) * q(h,kk);
        end
    end
        %
        %
end  % end of loop  for  h  = 1 : NLV
%
%
%  generate an identity matrix of size (Nchannels X Nchannels)
for kk = 1 : Nchannels
    for jj = 1 : Nchannels
        if(kk == jj)
            i(kk,jj) = 1;
        else
            i(kk,jj) = 0;
        end
    end
end
%
% compute the calibration matrix using the first latent variable
%
for jj = 1 : Ndyes
    for kk = 1: Nchannels
        cal_mat (jj, kk) = b(1) * w (kk,1) * q(1,jj) ;
    end
end
%
%
% set t matrix equal to i matrix
%
for kk = 1 : Nchannels
    for jj = 1 : Nchannels
        t(kk,jj) = i (kk,jj);
    end
end
%
%  finish computing the calibration matrix using the other latent variables
%
for f = 2 : NLV
    for kk = 1 : Nchannels
        for jj = 1 : Nchannels
```

| | |
|---|---|
| t_temp(kk,jj) = i (kk, jj) − w (kk, f−1)* p( f−1, jj); % | t_temp is of size |
| | %(Nchannels X Nchannels ) |

```
        end
    end
    %
    for kk = 1: Nchannels
        for jj = 1: Nchannels
            matrix_element = 0;
            for nn = 1 : Nchannels
                matrix_element = matrix_element + t (kk,nn) * t_temp (nn,jj);
            end
            new_t(kk,jj) = matrix_element;
        end
    end
    %
    % update the t matrix
      %
      for kk = 1: Nchannels
        for jj = 1: Nchannels
            t(kk,jj) = new_t(kk,jj);
        end
    end
    %
    for kk = 1 : Nchannels
        for jj = 1 : Ndyes
            cal_mat_temp(kk,jj) = w (kk,f) * q (f,jj);
        end
    end
    %
    for kk = 1 : Nchannels
        for jj = 1 :  Ndyes
            matrix_element = 0;
            for nn = 1 :  Nchannels
              matrix_element = matrix_element + b(f) * t (kk,nn) * cal_mat_temp (nn, jj);
            end
            new_cal_mat_temp(kk, jj) = matrix_element;
        end
    end
    %
    % transpose new_cal_mat_temp
    %
    for jj = 1 : Ndyes
        for kk = 1: Nchannels
            cal_mat_trans(jj,kk) = new_cal_mat_temp(kk,jj);
        end
    end
    %
    % update the calibration matrix
    %
    for jj = 1: Ndyes
        for kk = 1 : Nchannels
            cal_mat (jj,kk) = cal_mat(jj,kk) + cal_mat_trans(jj,kk);
        end
    end
end  % end of for loop ( for f = 2 : NLV)
%
% transpose cal_mat and return it as bilin_cal_mat
    for jj = 1: Ndyes
        for kk = 1 : Nchannels
            bilin_cal_mat (kk,jj) = cal_mat(jj,kk) ;
        end
    end
```

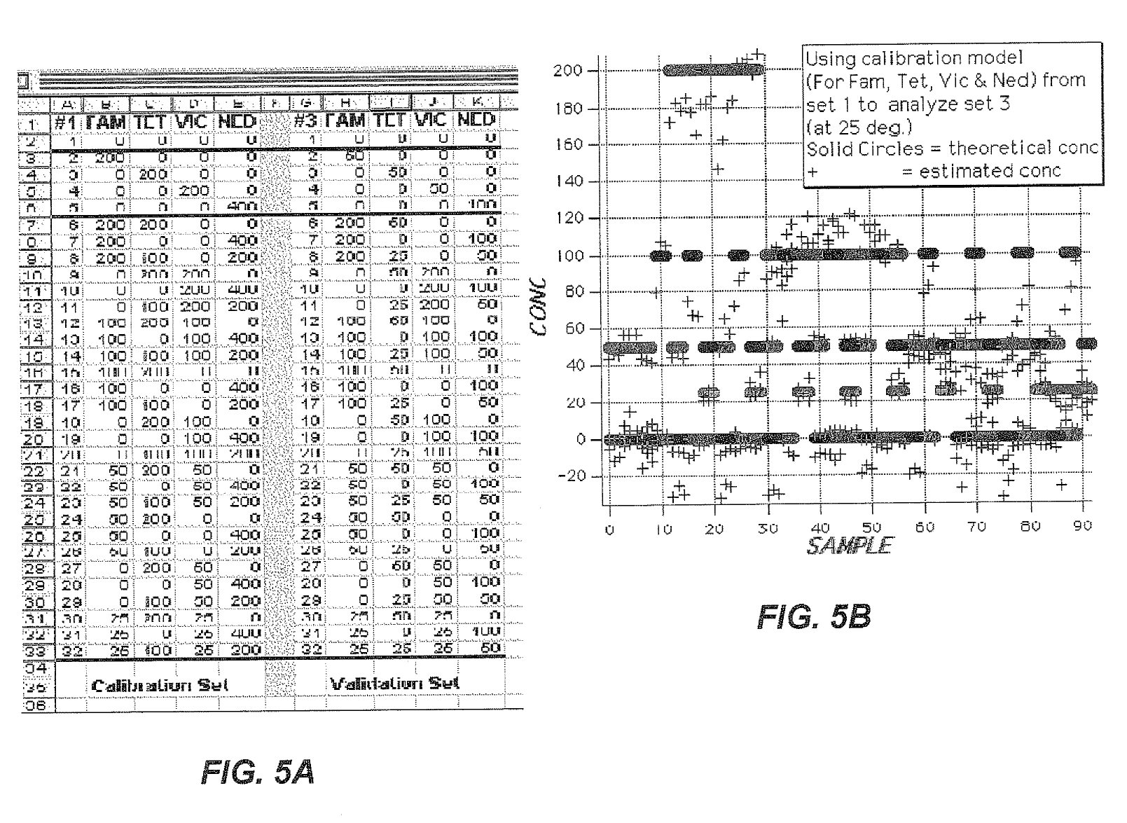

To validate this approach, FIG. 5A contains a calibration set used to populated a concentration matrix Y_{C} with the 32 samples. Each mixture from the 32 combinations was placed in three different well positions of a 96 well calibration plate creating duplicate entries. Entries in the calibration plate are recorded as containing the different mixtures from concentration matrix Y_{C}.

Next, a spectral matrix X_{S} is populated with spectral data gathered from a spectral detection instrument. Bilinear calibration is performed using X_{S} and Y_{C} as previously described creating a calibration matrix K_{calibrate} particular to the instrument and assay being used.

Sample spectrum is recorded and stored in X_{s-Unknown} from a sample plate X_{s-Unknown} of unknown mixtures of dyes and samples. The spectral values are multiplied by K_{calibrate} and the results Y_{c-Unknown} plotted in FIG. 5B. It can be seen that the theoretical concentrations and estimated concentrations using bilinear calibration operations validate this approach. Validation set in FIG. 5A contains the actual concentration amounts and are comparable with the estimated results in Y_{c-Unknown}.

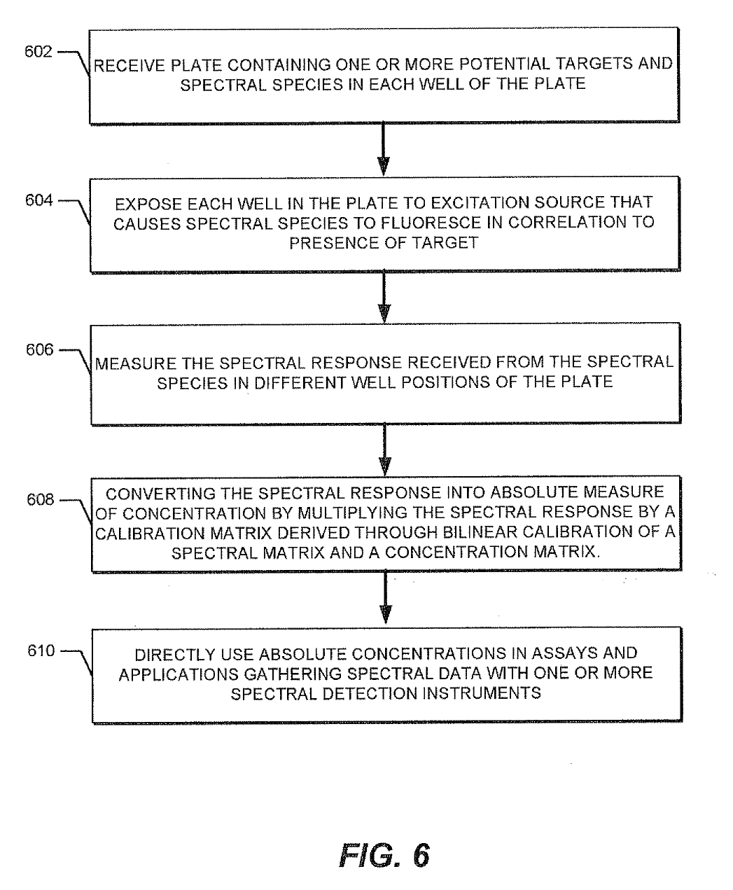

FIG. 6 is a flowchart diagram of the operations for converting between spectral response and absolute concentrations in accordance with implementations of the present invention. Initially, a sample plate is prepared with one or more potential targets and spectral species in each well of the plate (602). As used herein, targets refer to a specific polynucleotide sequence that is the subject of hybridization with a complementary polynucleotide, e.g., a blocking oligomer, or a cDNA first strand synthesis primer. The target sequence can be composed of DNA, RNA, analogs thereof, or combinations thereof. The target can be single-stranded or double-stranded.

Next, the spectral detection instrument exposes each well in the plate to an excitation source that causes spectral species to fluoresce in correlation to present of the target (604). The spectral detection instrument measures the spectral response received from the spectral species in different well positions of the plate (606).

The measured spectral response is transformed into an absolute measure of concentration by multiplying the spectral response by a calibration matrix derived from a spectral matrix and concentration matrix of known mixtures and concentration using bilinear calibration (608). Resulting absolute concentration amounts can be directly used in assays and applications gathering spectral data with one or more spectral detection instruments (610). As previously described, the spectral detection instruments can be the same model or different models as absolute concentration amounts produced in accordance with implementations of the present invention remain comparable across the lines.

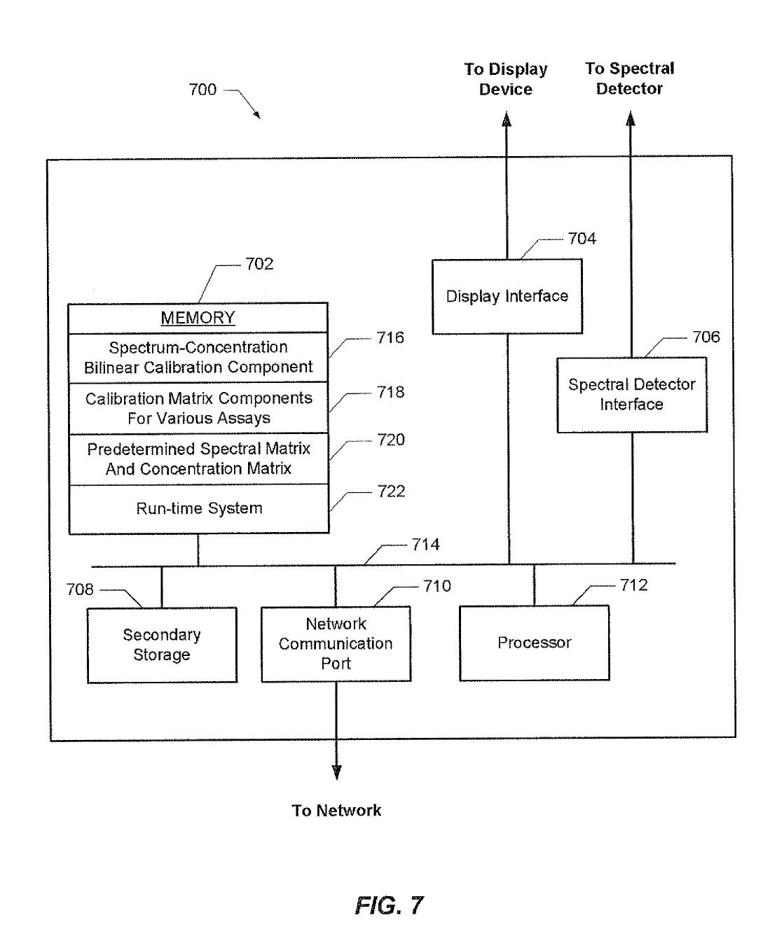

FIG. 7 is a block diagram of a system used in operating an instrument or method in accordance with implementations of the present invention. System 700 includes a memory 702 to hold executing programs (typically random access memory (RAM) or read-only memory (ROM) such as Flash), a display interface 704, a spectral detector interface 706, a secondary storage 708, a network communication port 710, and a processor 712, operatively coupled together over an interconnect 714.

Display interface 704 allows presentation of information related to operation and calibration of the instrument on an external monitor. Spectral detector interface 706 contains circuitry to control operation of a spectral detector including duplex transmission of data in real-time or in a batch operation. Secondary storage 708 can contain experimental results and programs for long-term storage including one or more calibration matrices, spectral matrices, concentration matrices and other data useful in operating and calibrating the spectral detector. Network communication port 710 transmits and receives results and data over a network to other computer systems and databases. Processor 712 executes the routines and modules contained in memory 702.

In the illustration, memory 702 includes a spectrum-concentration bilinear calibration component 716, calibration matrix component 718, predetermined spectral matrix and concentration matrix 720 and a run-time system 722 that manages the computing resources used to process data via these aforementioned routines.

Spectrum-concentration bilinear calibration component 716 includes routines for performing bilinear calibration in accordance with aspects of the present invention. Some of the inputs to this component include a spectral matrix having a recorded spectral response on a particular spectral detector instrument and a concentration matrix of known concentrations and mixtures of spectral species/dyes.

Calibration matrix component 718 is the resulting matrix used to transform spectral results into absolute concentrations. Typically, the calibration matrix component 718 is tailored to each different assay and application. Multiple calibration matrices may be used for different assays and applications. For example, the calibration matrix component 718 takes into account likely mixtures of dyes used by the assay and creates transformations resilient to spectral overlap in the spectral species/dyes used in the assay.

Predetermined spectral matrix and concentration matrix 720 contain a pair of matrices with both the recorded spectral response and the corresponding known concentration mixtures generating the response. Operating on these matrices in accordance with the present invention generates a calibration matrix that allows transformations between a spectral response and an absolute measure of concentration.

Run-time system 722 manages system resources used when processing one or more of the previously mentioned modules. For example, run-time system 722 can be a general-purpose operating system, an embedded operating system or a real-time operating system or controller.

System 700 can be preprogrammed, in ROM, for example, using field-programmable gate array (FPGA) technology or it can be programmed (and reprogrammed) by loading a program from another source (for example, from a floppy disk, an ordinary disk drive, a CD-ROM, or another computer). In addition, system 700 can be implemented using customized application specific integrated circuits (ASICs).

Embodiments of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

Thus, the invention is not limited to the specific embodiments described and illustrated above. Instead, the invention is construed according to the claims that follow.

What is claimed is:

1. A computer implemented method of generating a calibration matrix for a spectral detector instrument, comprising:
receiving a calibration plate containing one or more dye mixtures in each well of the calibration plate at known absolute concentration;
preparing a concentration matrix based on the dyes used in the assay and the different dye mixtures used in the calibration plate;
exposing the calibration plate to an excitation source operating over a range of spectra that causes the one or more spectral species in each of the wells to fluoresce;
generating a spectral matrix containing emission spectra for the different dye mixtures of dyes as gathered by the spectral detector instrument at different points in the range of spectra; and
performing a bilinear calibration operation on the concentration matrix and the spectral matrix as to determine a calibration matrix relating spectra directly to absolute concentrations.

2. The method of claim 1 further comprising:
reusing the same calibration plate to generate a calibration matrix for one or more different spectral detector instruments in a single platform.

3. The method of claim 1 further comprising:
reusing the same calibration plate to generate a calibration matrix for one or more different spectral detector instruments from more than one different platforms.

4. The method of claim 1 further comprising:
reusing the same calibration plate to generate an updated calibration matrix for one instrument over time.

5. The method of claim 1, wherein the calibration plate is selected from a set of plates including a 96-well plate, a 384-well plate and a plate having a multiple of 96-wells.

6. The method of claim 1, wherein the spectral species includes one or more dyes selected from a set including: FAM, SYBR Green, VIC, JOE, TAMRA, NED, CY-3, Texas Red, CY-5, Hex and ROX.

7. The method of claim 3 wherein one dye is used as a passive reference to normalize the spectral species in each well of the calibration plate.

8. The method of claim 1 wherein the excitation source is selected from a set of excitation sources including: a laser device, Halogen Lamp, arc lamp, Organic LED and an LED device.

9. The method of claim 1 wherein generating the spectral matrix further comprises:
determining a dye mixture of dyes based upon predetermined dye mixture information associated with a well in a plate; and
recording the spectral response for the dye mixture across a range of one or more discrete spectra emitted by the spectral detector instrument.

10. A method of identifying spectral emission from a spectral detector instrument comprising:
receiving a plate containing one or more potential targets and spectral species in each well of a plate having one or more wells;
exposing each well in the plate to an excitation source that cause the spectral species to fluoresce in correlation to the presence of the target;
measuring the spectral response received from the spectral species in different well positions of the plate; and
transforming the spectral response into an absolute measure of dye concentration by multiplying the spectral response by a calibration matrix derived through bilinear calibration of a spectral matrix and a concentration matrix.

11. The method of claim 12 further comprising:
directly using the absolute measure of dye concentration transformed from spectral response collected from multiple instruments in an experiment.

12. The method of claim 13 wherein the measured signal values are collected over time from each of the multiple instruments.

13. The method of claim 12, wherein the plate containing one or more targets and the calibration plate is selected from a set of plates including a 96-well plate, a 384-well plate and a plate having a multiple of 96-wells.

14. The method of claim 12, wherein the assay includes one or more probes selected from a set including: FAM, SYBR Green, VIC, JOE, TAMRA, NED, CY-3, Texas Red, CY-5 and ROX.

15. The method of claim 16 wherein ROX is used as a passive reference.
